(19) United States
(12) Patent Application Publication
(10) Pub. No.: US 2014/0265412 A1
(43) Pub. Date: Sep. 18, 2014

(54) Adjustable Bedliner Ballast System For Vehicles

(71) Applicants: Jennifer Ellis, Lothian, MD (US); Tom Ellis, Lothian, MD (US)

(72) Inventors: Jennifer Ellis, Lothian, MD (US); Tom Ellis, Lothian, MD (US)

(21) Appl. No.: 13/829,564

(22) Filed: Mar. 14, 2013

(51) Int. Cl. B60R 9/00; B60R 13/01

(52) U.S. Cl. CPC B60R 9/00; B60R 13/01; B60R 2013/016
USPC 296/39.2

(57) ABSTRACT

The present invention is drawn to a bedliner ballast system for pick-up trucks, vans and other vehicles to allow the operators of vehicles to increase traction on the driving wheels by adding and removing weight to the bed of their vehicle and therefore adjusting the traction of the driving wheels without sacrificing load carrying space. The design permits the owner to easily and quickly add or remove weight as needed by using a liquid contained within the bed liner. Liquid may be added to directly weight, for example, the rear wheels with a garden hose or water faucet at a filling station while preserving the entire rear bed for passengers or freight and the additional load may be easily and quickly removed. The design permits custom modification for a variety of vehicles and vehicle configurations.

### BACKGROUND OF THE INVENTION

1. Field of the Invention

This invention relates to adjustable ballast systems for vehicles.

2. Background of the Invention

Vehicles adapted for carrying loads such as pick-up trucks and vans may have difficulties when travelling unloaded in the winter because of the lack of weight over the rear wheels. These vehicles, for example, are usually engineered for optimum handling with a load in the rear over the drive wheels. Traction and handling problems may arise when the vehicle is traveling without a load over the drive wheels, particularly in snowy or icy conditions. Many owners try to offset this by placing heavy objects in the load area such as sandbags. However, this tends to be very inconvenient because the items take up space needed for cargo or passengers may cause dangerous shifts in weight by moving around and may be tiring and difficult to handle for women and individuals with some disability.

### Shortcomings of the Existing Art

None of the existing prior art discloses or describes to a hollow removable bedliner for a vehicle to which ballast may be added or removed, uses a liquid, and which include baffles and a vent.

One set of devices in the prior art utilizes closed containers filled with various materials and placed inside the bed of the vehicle. However, these devices are usually large and bulky and difficult for some drivers to handle. Furthermore, many of these devices require a separate bedliner to increase friction on top of these devices. Furthermore, once the truck is loaded and the additional ballast is no longer needed, the devices must be somehow un-weighted to avoid limiting the vehicle can carry. Mayer in U.S. Pat. No. 6,079,741, Malinowski, et al. in U.S. Pat No. 6,027,139 and Hartenburg in U.S. Pat. No. 5,494, 395 are illustrative of these devices.

Another example Ryan et al. in U.S. Pat. 7,624,273 disclose a large mat for placing in the rear of a pickup truck. The mat has cross-members integrally attached to the mat to furnish the needed weight. When not needed the mat is to be rolled up and stored, presumably in the bed of the truck. There are several disadvantages to this system. First it would be very difficult to get sufficient weight in such an arrangement. On the other hand even a limited weight would be difficult for many individuals to handle. The mat once rolled up would take up needed space and the top of the mat would create problems in the bed. Mayer U.S. Pat. No. 6,079,741 discloses a pair of ballast tanks for containing sand to be placed in the rear of a pick-up truck. This device presents similar difficulties. The tanks would be heavy and difficult to handle even when empty. They would be difficult to empty and would occupy substantial space needed for cargo. A significant supply of sand is frequently not available and filling may be difficulty in freezing conditions. Additional devices are limited to solid ballast such as sand include Ryan et al. 273, Malinowski, et al. 139, Anderson U.S. Pat. No. 5,330,227, Chamberlain, U.S. Pat. No. 5,172,953 and Tackett, U.S. Pat. No. 5,657,916.

Several devices utilize a semi-permanent bed-liner located inside the rear part of the truck and providing space for ballast between the liner and the truck body. These devices are difficult to remove, generally requiring several individuals, reduce the load capacity and essentially require that the additional ballast be carried throughout the winter season. They generally use solid ballast with the accompanying disadvantages described above. In addition to those listed above, these semi-permanent liners include Chamberlain, U.S. Pat. No. 5,172,953, Smith, U.S. Pat. No. 4,396,914.

Of the prior art Patents that potentially use liquid ballast, none provide internal baffles to reduce the internal movement of the liquid to prevent potentially dangerous “sloshing” effects when suddenly stopping or negotiating sharp curves, or to provide internal structural support to the ballast system.

### SUMMARY OF THE INVENTION

The present invention is drawn to a hollow bedliner for a vehicle with a rear bed to which ballast may be conveniently added or removed such that the traction and steering of the vehicle is improved particularly in wet, snowy or icy conditions. Certain embodiments of the invention include the use of liquid ballast and some of these embodiments also include adaptions which allow the use of pressurized fluid such as air to assist in adjusting the ballast content.

### BRIEF DESCRIPTION OF THE FIGURES

FIG. 1 is a view of the bed of a load carrying vehicle illustrating one embodiment of the invention.

FIG. 2 is a side view of one embodiment of the invention.

FIG. 3 is a cross-section illustrating the construction of interior baffles to limit the movement of liquid inside of the ballast bedliner in one embodiment of the invention.

FIG. 4 illustrates the use of screw caps with hasps for locks which may be attached to the tops of the fill and/or vent structures.

### DETAILED DESCRIPTION OF THE INVENTION

The present invention is drawn to a bedliner for the bed of a load-carrying vehicle which can hold a removable ballast so as to improve the handling and traction qualities of the vehicle for varying load and road surface conditions.

Load carrying vehicles such as pick-up trucks and passenger vans are generally designed for optimum handling and traction characteristics with a full load and dry pavement. Often, particularly in inclement weather with wet, snowy or icy roads, an empty or partially loaded vehicle may have insufficient loading on the rear wheels to provide good handling and/or traction for the rear wheels, particularly when the rear wheels are driving wheels. The invention comprises a hollow bedliner for the bed of the load carrying vehicle, capable of holding a liquid ballast material such as water which can be added to or drained from the liner and so constructed so as to place added weight on the rear wheels. There are fill structures for adding the ballast and drain structures for emptying the ballast. In some embodiments these fill structures may also be used to vent or admit air into the bedliner as the ballast is added or drained. In one embodiment, the bedliner contains internal structural cross-members which provide both internal strength and serve as baffles to modify the shifting of the ballast. These structures could be designed to either serve solely as baffles or solely as structural supports or any combination. In an additional embodiment, the system is sealed by means of air-tight caps and air valves are included to allow the addition of compressed air to facilitate the emptying of the ballast.

The bedliner is preferably constructed from strengthened plastic, but could be constructed of other materials having the appropriate strength and weight characteristics including metals, hard rubber or any other material. The bedliner may be attached to the frame as illustrated in FIG. 3, which shows details of a potential attachment of the bedliner to the bed of the vehicle by means well known in the art, which would include the use of bolts or rivets, welding (either metal welding or any other form of welding utilizing the melting of one or more of the attached members), enclosing the chambers with structural parts of the truck bed, or even a bedliner fabricated to fit closely within the bed and held in place by its own weight or fabricated to fit closely inside the bed of the truck. In addition the bedliner could be fabricated so as to be attached by expansion bolts fitted into the openings in the sides normally utilized for the stakes supporting removable side extension.

In addition the bedliner ballast system could be fabricated integrally with the bed of the truck itself with the top of the structure acting as the bottom of the bed of the vehicle. In another embodiment, the bedliner could have independent cells which can be filled or emptied independent of each other so as to adjust to location and weight of the ballast added.

In addition the caps on the vent/fill pipes could be fitted with valves allowing the introduction of compressed gas such as from hoses used to adjust the pressure in tires so as to accelerate the emptying of the liquid from the bedliner.

### EXAMPLES

Now referring to the drawings and more particularly FIG. 1 this embodiment of the invention of a ballast bedliner for use the bed of a truck 10 on wheels 13 comprising two vent/fill pipes 12 disposed on each side of the bed 11 so that they may be conveniently filled from either side. A drain 14 is positioned at the bottom of the liner at the back of the bed. The liner is constructed with longitudinal interior baffles 15 which are porous and which allow the liquid to move through but moderates sloshing and also add structural strength to the top of the bedliner 1.

FIG. 2 illustrates details from another view of one embodiment of this invention. This figure shows the structures describe above plus the wheel cuts 17 in the bedliner 10.

FIG. 3 shows a cross-section illustrating the details of the interior baffles with openings 18 to allow the movement of the liquid ballast, but moderating the “sloshing” effects and offering support to the upper side of the bedliner.

FIG. 4 illustrates the screw-on cap for the vent/fill pipe including hasps 19 for use of a lock.

Having now fully described this invention, it will be understood to those of ordinary skill in the art that the same can be performed within a wide and equivalent range of conditions, formulations, and other parameters without affecting the scope of the invention or any embodiment thereof. All patents and publications cited herein are incorporated by reference in their entirety.

We claim:

1. A bedliner ballast system for attachment to the bed of a vehicle comprising:
a) A bedliner for a vehicle comprising a hollow structure fabricated to contain liquid ballast and to closely conform to the compartment of said load carrying vehicle to which said liquid ballast may be added or removed;
b) said hollow bedliner comprising one or more fill structures for adding liquid to said hollow bedliner;
c) said hollow bedliner further comprising one or more drain structures for draining said liquid ballast from said bedliner;
d) said hollow bedliner further comprising interior baffles designed to moderate the movement of the liquid ballast inside the said hollow structure and to form intermediate supports to support the top of said hollow structure;
e) said bedliner ballast system further comprising one or more vent structures for venting or admitting air as ballast liquid is added or removed from said hollow bedliner.

2. The bedliner ballast system of claim 1 wherein said fill structure is fitted with a cap and provided with a valve system for the admission of compressed gas.

3. The bedliner ballast system of claim 1 wherein said bedliner system is comprised of separate independent compartments wherein the amount and location of said liquid ballast may be adjusted to fit various configurations or loads within the vehicle.

4. The bedliner ballast system of claim 1 wherein said fill and/or said vent structures are comprised of two or more fill pipes located on each side of the vehicle so as to make dispensing said liquid ballast into and/or out of said hollow structure more convenient.

5. The bedliner ballast system of 1 wherein the liquid ballast to be used in said system is water mixed with a biodegradable or otherwise environmentally friendly antifreeze component.

6. A load carrying vehicle comprising frame and a liquid ballast system positioned over the driving wheels attached to said frame, said ballast system comprising a hollow vessel for holding said liquid ballast and means for adding and for removing said liquid ballast and baffles means located within said liquid ballast system to moderate movement of said liquid ballast during maneuvering of said vehicle.
